(19) United States
(12) Patent Application Publication
(10) Pub. No.: US 2016/0114740 A1
(43) Pub. Date: Apr. 28, 2016

(54) FIXTURE FOR A VEHICLE

(71) Applicant: DAEHAN SOLUTION CO., LTD., INCHEON (KR)

(72) Inventor: Choong Ho KWON, Seoul (KR)

(73) Assignee: DAEHAN SOLUTION CO., LTD., INCHEON (KR)

(21) Appl. No.: 14/633,485

(22) Filed: Feb. 27, 2015

(30) Foreign Application Priority Data
Oct. 24, 2014 (KR) 10-2014-0145409

(51) Int. Cl. B60R 13/02; B60Q 3/02; B29C 45/00; B60J 5/04

(52) U.S. Cl. CPC B60R 13/0206; B60J 5/0468; B60Q 3/0203; B60R 13/0275; B29C 45/00; B29L 2031/3055

(57) ABSTRACT

A fixture for a vehicle, which is configured so that outer side portions of retaining arms actually fixing a store (for example, a headliner, a room lamp, a head lamp, or an indoor handle) are not directly in contact with an installation hole, in which the fixture is installed, and the retaining arms are prevented from being separated from the installation hole due to an external force applied to the indoor handle or a vibration transmitted from the vehicle. In particular, the fixture for the vehicle is configured so that the retaining arms actually serving as hooks are formed at both sides of a base to face each other, to increase a width of each retaining arm, and thus to increase a fixing force which catches and fixes the retaining arms into the installation hole.

### CROSS-REFERENCE TO RELATED APPLICATION

This application claims priority to and the benefit of Korean Patent Application No. 10-2014-0145409, filed on Oct. 24, 2014, the disclosure of which is incorporated herein by reference in its entirety.

### BACKGROUND

1. Field of the Invention

The present invention relates to a fixture for a vehicle, and more particularly, to a fixture for a vehicle, which is configured so that retaining arms inserted and caught into an installation hole to be hooked are not directly in contact with the installation hole, and also a width of the retaining arm is increased, and thus the retaining arm is prevented from being separated or escaping from the installation hole, even though the fixture is twisted when a passenger pulls an indoor handle, or a vibration is generated in the vehicle, and also which is configured to be in point-contact between the retaining arms, thereby minimizing generation of a noise.

2. Discussion of Related Art

Generally, various construction elements are assembled in a vehicle using a fixture (a clip module). For example, the construction elements include a room lamp, a head lamp, and an indoor auxiliary handle. At this time, the used fixture may be separately manufactured and used according to each construction element. However, in an aspect of productivity and cost reduction, one kind of fixture is generally developed and applied to all places which are required to be coupled in a clip manner. Patent documents 1 to 3 show examples in which a fixture (a module clip) capable of being used in another construction element is used to fix a headliner.

Patent documents 1 provides an auxiliary handle fixture for a headliner module of a vehicle, in which a base 110 assembled between a body panel 10 and a headliner 20 is provided at a base end, and a hook 120 integrally bent from the base 110 to be inserted and coupled into a coupling hole 11 of the body panel 10 is formed at a fore-end, wherein the hook 120 includes two pairs of supporting arms 121 having supporting portions 121a bent from both sides of the base 110 to be inclined upward in directions facing each other and flanges 121b bent downward from upper ends of the supporting portions 121a, one pair of retaining arms 123 formed between the two pairs of supporting arms 121 to be bent from centers of the flanges 121b and to be inclined downward in directions far away from each other, retaining portions 124 bent from lower ends of the retaining arms 123 to be inclined downward in directions facing each other, retaining jaws 125 bent downward from lower ends of the retaining portions 124 to be caught by a circumferential surface 11a of the coupling hole 11 of the body panel 10, and insertion guide beads 126 formed at centers of the retaining arms 123 to extend from upper ends to lower ends and to protrude in directions far away from each other.

Patent document 2 relates to an auxiliary handle fixture for a headliner module of a vehicle, which has a simple manufacturing process and a low manufacturing cost, and is configured to restrict generation of noise when being installed and used in the vehicle. In the auxiliary handle fixture for the headliner module of the vehicle, in which a base 110 assembled between a body panel 10 and a headliner 20 is provided at a base end, and a hook 120 integrally bent from the base 110 to be inserted and coupled into a coupling hole 11 of the body panel 10 is formed at a fore-end, the hook 120 includes supporting arms 121a bent from both sides of the base 110 to be inclined upward in directions facing each other and flanges 121b formed to extend from upper ends of the supporting arms 121a to both sides of the supporting arms 121a and to be bent downward, two pairs of retaining arms 122 bent from both sides of the flanges 121b to be inclined downward in directions far away from each other, retaining portions 123 bent from lower ends of the retaining arms 122 to be inclined downward in directions facing each other, retaining jaws 124 bent downward from lower ends of the retaining portions 123 to be caught by a circumferential surface 11a of the coupling hole 11 of the body panel 10, and at least one noise preventing protrusion 125 formed to restrict generation of noise due to mutual contact of the flanges 121b configured to protrude from opposed surfaces of the flanges 121b to face each other.

Patent document 3 relates to an auxiliary handle fixture for a headliner module of a vehicle, including a base 110 assembled between a body panel 10 and a headliner 20, and a hook 120 bent from the base 110 to be inserted and coupled into a coupling hole 11 of the body panel 10, wherein the hook 120 includes one pair of supporting arms 121 generally formed in a “T” shape and having flanges 121a bent from upper ends thereof to face each other and to be in contact with each other, retaining arms 122 formed to gradually extend outward from upper horizontal sides of the supporting arms 121 toward a bottom and bent inward at an end thereof to form hooking portions 122a, cut-away portions 123 formed at portions, in which transverse and longitudinal portions of each supporting arm 121 are met, to be gradually directed upward toward the longitudinal portions, and shoulders 124 formed to extend from outer frames of connection portions between the retaining arms 122 and the flanges 121a, wherein at least one pair of movement preventing protrusions 112 are integrally formed at portions of the base 110 cut in the form of a “ [symbol] ” shape to face each other toward the flanges 121a, and the pair of movement preventing protrusions 112 are gradually bent inward toward a top thereof, and at least one nose preventing protrusion 121b is further provided at one of both opposed surfaces of the one pair of flanges 121a to be in point-contact.

However, the conventional fixtures are mainly formed in clip shapes and have a structure which is not moved once they are fixed. For example, in case of a room lamp, a head lamp, and a headliner, since they are not moved and an external force is hardly applied to them, there is no problem. However, when the indoor handle which is grasped by a passenger and to which an external force is applied is fixed, there are some problems as follows.

(1) As illustrated in FIGS. 1 to 3, if the hook is inserted into the coupling hole, the two movement preventing protrusions 112 support the fixture, while being in contact with both opposed surfaces of the coupling hole, and the retaining arms 121 and 122 are caught by the rest both surfaces of the coupling hole.

(2) At this time, a gap between the retaining arms 121 and 122 and the inner surface of the coupling hole is generated. The gap acts as a space in which the retaining arms 121 and 122 may be deformed.

(3) That is, the retaining arms 121 and 122 are configured to endure a force which is directed from a top to a bottom of the base 110. However, when the indoor handle is actually pulled, the retaining arms 121 and 122 may be twisted by a force inclined to one side as well as may receive the force which is directed from the top to the bottom, as intended.

(4) The twisting force is directly transmitted to the retaining arms 121 and 122, and the retaining arms 121 and 122 may be inclined to one side due to the twisting force, and the fixture may escape through a gap between the retaining arms 121 and 122 and the coupling hole.

(5) Therefore, noise may be generated between the retaining arms 121 and 122 and the coupling hole, and also the indoor handle may fall into an interior of the vehicle together with the fixture, and thus a safety accident may occur.

(6) This problem may occur due to vibration generated in the vehicle as well as the twisting force applied to the retaining arms.

(7) Meanwhile, in the conventional fixture, since the retaining arms are formed between the supporting arms or at both sides of the supporting arms, there is a problem in that the retaining arms actually serving as the hooks are formed to have a large size. Therefore, the hooking function, i.e., the supporting force of the retaining arms is limited.

(Patent document 1) Korean Patent Publication No. 10-2013-0090942 (published on Aug. 16, 2013)

(Patent document 2) Korean Patent No. 1359424 (registered on Jan. 29, 2014)

(Patent document 3) Korean Patent No. 1391230 (registered on Apr. 25, 2014)

### SUMMARY OF THE INVENTION

The present invention is directed to a fixture for a vehicle, which is configured so that outer side portions of retaining arms actually fixing a store (for example, a headliner, a room lamp, a head lamp, or an indoor handle) are not directly in contact with an installation hole, in which the fixture is installed, and the retaining arms are prevented from being separated from the installation hole due to an external force applied to the indoor handle or a vibration transmitted from the vehicle, and thus noise generation due to partial separation of the retaining arms is restricted, and a safety accident which may occur while the indoor handle falls into an interior of the vehicle due to complete separation thereof is prevented in advance.

Also, the present invention is directed to a fixture for a vehicle, which is configured so that the retaining arms actually serving as hooks are formed at both sides of a base to face each other, to increase a width of each retaining arm, and thus to increase a fixing force which catches and fixes the retaining arms into the installation hole, thereby preventing the separation of the fixture or the safety accident in advance.

Also, the present invention is directed to a fixture for a vehicle, which is configured so that the fixture is guided by a guide when being inserted into the installation hole, and thus easily and rapidly inserted into the installation hole, and the store is installed at an exact location.

According to an aspect of the present invention, there is provided a fixture (F) for a vehicle, which is inserted into an installation hole (11) formed in a body panel (10) to install a head lamp, a room lamp, a headliner, or an indoor handle, including a base (100) having a fastening hole (110) formed in a center thereof; one pair of retaining arms (120) configured to extend at both sides of the base (100) based on the fastening hole (110) to face each other, and to be in contact with each other above the fastening hole (110), and then to be spread outward toward a lower side thereof, and having hooking portions (122) formed at ends thereof to be elastically deformed and thus to be caught and fixed into the installation hole (11), and first cut-away portions (125) formed at both sides thereof by partly cutting away edges of portions thereof which are spread outward by a predetermined width; and four guides (130) configured to protrude from the base (100) and to be located between both sides of each retaining arm (120) and an inner surface of the installation hole (11), and formed to protrude upward when the fixture (F) is inserted.

The retaining arms (120) may have second cut-away portions (123) formed by partly cutting away portions bent above the fastening hole (110) to easily achieve an elastic deformation. Also, each retaining arm (120) may have at least one reinforcing bead (121) formed to reinforce a structural strength thereof in a lengthwise direction. Further, the retaining arms (120) may have at least one contacting protrusion (124) formed at each of both surfaces thereof which are in contact with each other above the fastening hole (110), such that one contacting protrusion (124) formed at one retaining arm (120) is not in contact with the other contacting protrusion (124) formed at the other retaining arm (120).

The guides (130) may be formed to be bent at least twice, such that adjacent surfaces thereof are in contact with each other.

The fixture may be formed by press processing of a steel material or injection molding of a synthetic resin.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a representative view of Patent document 1;

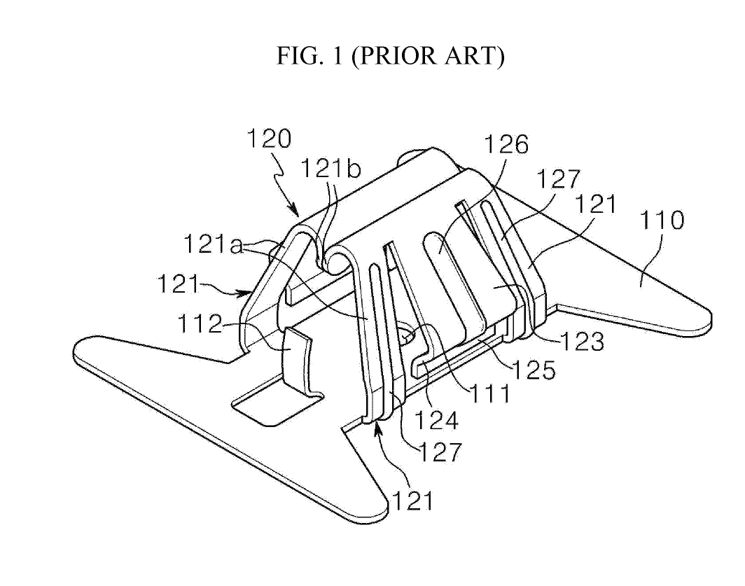

FIG. 2 is a representative view of Patent document 2;

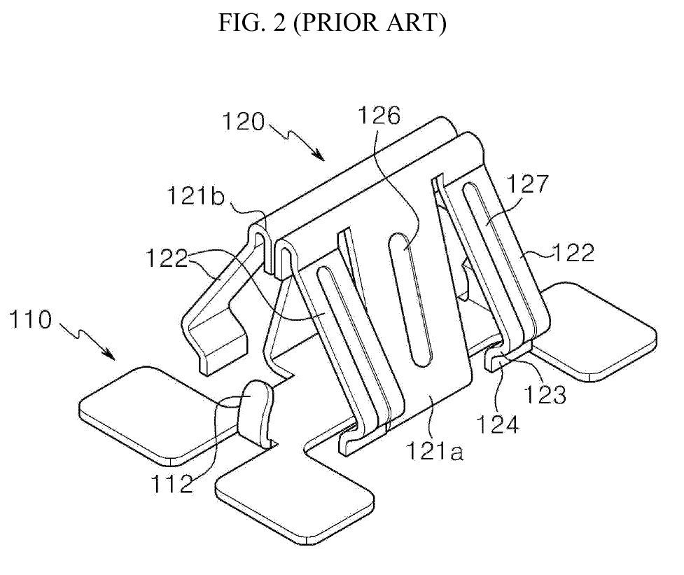

FIG. 3 is a representative view of Patent document 3;

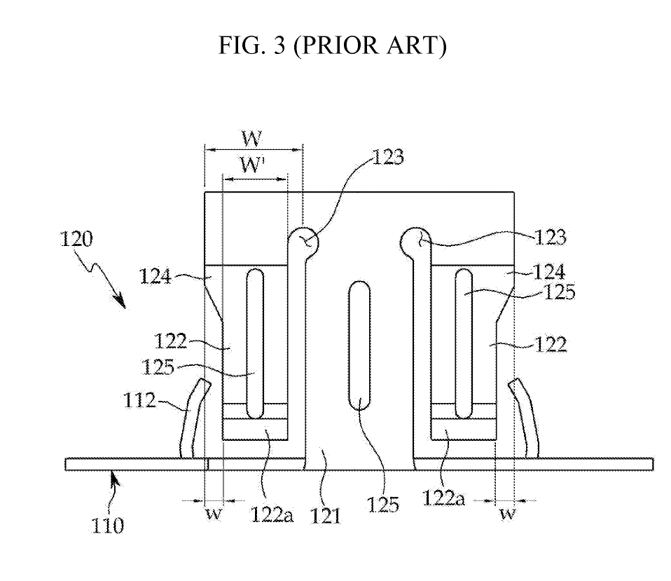

FIG. 4 is a perspective view illustrating an entire shape of a fixture for an indoor handle according to the present invention;

FIG. 5 is a cross-sectional view illustrating a state in which the indoor handle is installed at a body panel using the fixture for the indoor handle according to the present invention; and

FIG. 6 is a side view illustrating a state in which the fixture for the indoor handle according to the present invention is inserted and installed into the installation hole formed in the body panel.

| | |
|---|---|
| 100: base | 110: fastening hole |
| 121: reinforcing bead | 120: retaining arm |
| 122: hooking portion | 123: second cut-away portion |
| 124: contacting protrusion | 130: guide |

### DETAILED DESCRIPTION OF THE INVENTION

Preferred embodiments of the present invention will be described in detail below with reference to the accompanying drawings. It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

(Construction)

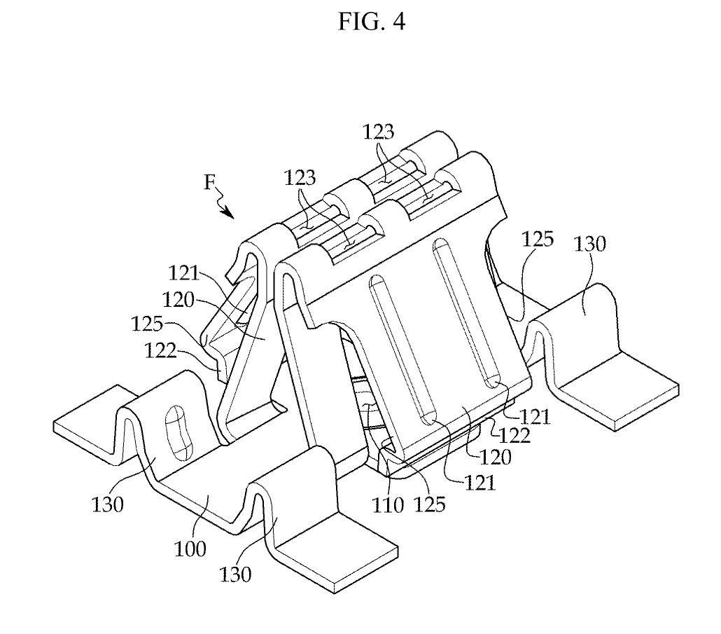

As illustrated in FIGS. 4 to 6, a fixture F for a vehicle according to the present invention which is inserted into an installation hole 11 formed in a body panel 10 to fix a store (for example, a headliner, a room lamp, a head lamp, or an indoor handle) includes a base 100 having a fastening hole 110 formed in a center thereof, one pair of retaining arms 120 integrally formed with the base 100 so that each end thereof is caught into the installation hole 11 to fix the store, and four guides 130 formed to protrude from the base 100 and to be located at both sides of each retaining arm 120.

In particular, the guides 130 are configured to be located between the retaining arms 120 and an inner side of the installation hole 11 and to guide the fixture F, when the fixture F of the present invention is inserted into the installation hole 11, and thus the fixture F may be easily inserted and installed into the installation hole 11.

And the guides 130 allows the retaining arms 120 not to be in contact with the installation hole 11, and thus even when a twisting force or a vibration is applied to the retaining arms 120, the retaining arms 120 are prevented from escaping from or being separated from the installation hole 11, and also noise generated when the separated retaining arms 120 collide with other construction elements is prevented, and also a safety accident in which the indoor handle 40 is separated and then falls into an interior of the vehicle may be prevented in advance.

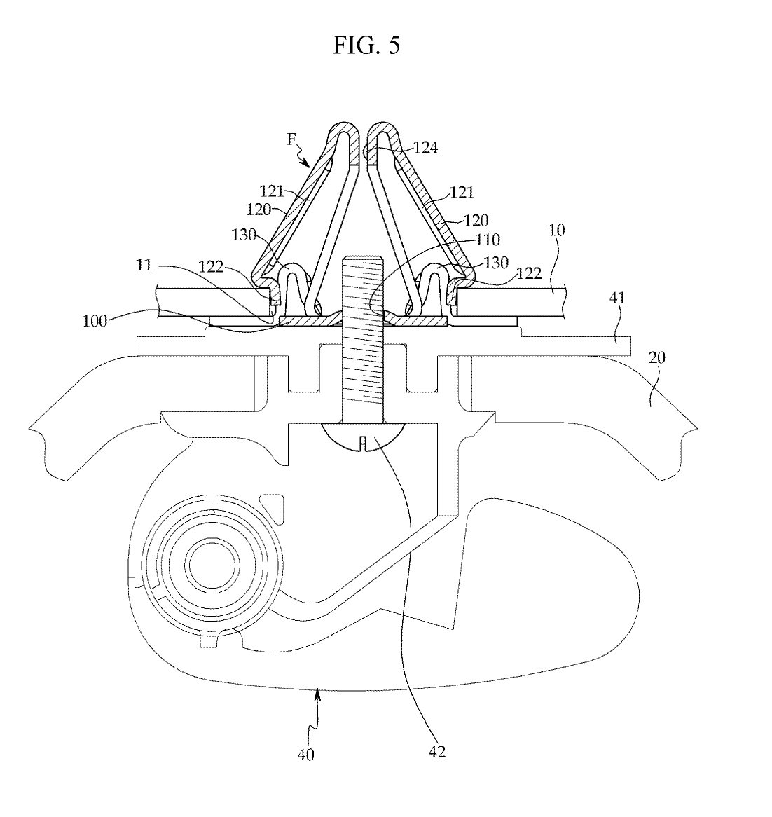

The detailed description of such a structure is as follows. Here, the fixture F of the present invention is used to fix the headliner, the room lamp, the head lamp, the indoor handle, or the like. In the specification, as illustrated in FIG. 5, it is assumed that the fixture F is installed at the indoor handle to which an external force is most frequently applied in an installed state, and thus which may be separated or disassembled. In FIG. 5, an unexplained reference numeral 20 is the headliner, 41 is a fixture plate installed between the body panel 10 and the headliner 20, 40 is the indoor handle, and 42 is a fastening means, such as a screw, onto which the indoor handle 40, the headliner 20, and the fixture plate 41 are sequentially inserted and which is fastened into the fastening hole 110.

As illustrated in FIGS. 4 to 6, the base 100 is formed in a plate shape having a predetermined size. In the preferred embodiment of the present invention, the base 100 is formed in a symmetrical shape, preferably, a rectangular shape or a square shape, such that the external force generated when the indoor handle is pulled is uniformly applied.

Further, as illustrated in FIGS. 4 to 6, the base 100 has the fastening hole 110 formed at the center thereof. The fastening means (not shown) such as the screw which is inserted into the indoor handle is fastened in the fastening hole 110 to fix the indoor handle.

As illustrated in FIGS. 4 to 6, one pair of retaining arms 120 are formed by bending both edges of the base 100. At this time, the retaining arms 120 are bent to face each other, to be in contact with each other above the fastening hole 110, and then to be spread outward toward a lower side thereof.

A hooking portion 122 is formed at a lower end of each retaining arm 120 to be caught by an edge of the installation hole 11, when the fixture F of the present invention is inserted into the installation hole 11.

In the preferred embodiment of the present invention, the retaining arms 120 have second cut-away portions 123 formed by partly cutting away bent portions in contact with each other above the fastening hole 110. Since a width of each retaining arm 120 is too wide, and thus stiffness of the bent portion is also too strong, great power may be required to elastically deform the retaining arms 120. Therefore, to easily deform the retaining arms 120, the second cut-away portions 123 are formed to be cut in a predetermined size and thus to easily achieve the elastic deformation.

Further, in the preferred embodiment of the present invention, each retaining arm 120 may have at least one reinforcing bead 121 formed to reinforce a structural strength thereof. The drawings illustrate an example in which two reinforcing beads 121 are formed at each retaining arm 120 in a lengthwise direction to protrude toward an inner side of the fixture F.

In the preferred embodiment of the present invention, the pair of retaining arms 120 are formed at the base 100 to be symmetrical with respect to the fastening hole 110. Therefore, even when the fastening means is fastened in the fastening hole 110 and an external force is applied thereto, the external force is uniformly dispersed by the symmetrically disposed retaining arms 120, and thus the fixture F may be stably supported.

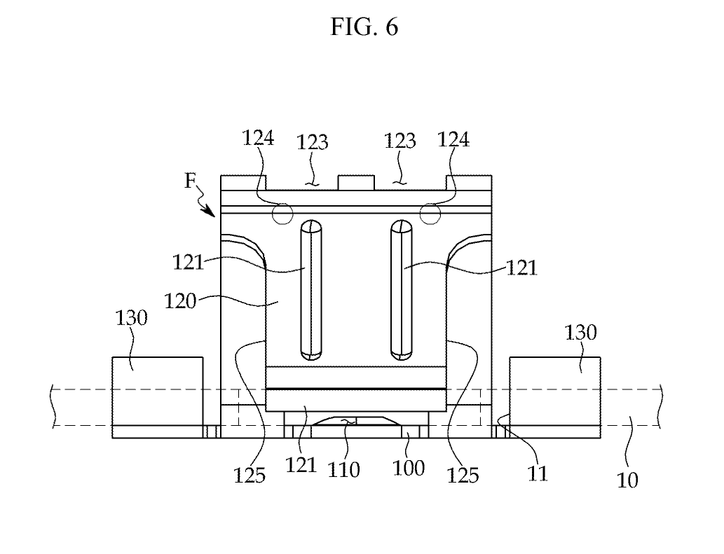

Further, in the preferred embodiment of the present invention, as illustrated in FIGS. 5 and 6, the retaining arms 120 have at least one contacting protrusion 124 formed at each of both surfaces thereof which are in contact with each other above the fastening hole 110. At this time, each contacting protrusion 124 is formed not to be in contact with other contacting protrusion 124 formed at another retaining arm 120. That is, the contacting protrusions 124 are formed at the pair of retaining arms 120, respectively, such that one contacting protrusion 124 formed at one retaining arm 120 is not in contact with the other contacting protrusion 124 formed at the other retaining arm 120. Therefore, a contact area between the retaining arms 120 may be minimized, and thus, when the fixture F of the present invention is used, a noise generated while the retaining arms 120 are in contact with each other may be minimized.

Finally, as illustrated in FIGS. 4 and 6, in the preferred embodiment of the present invention, the retaining arms 120 have first cut-away portions 125 formed at both sides thereof. At this time, the first cut-away portions 125 are formed at portions of the retaining arms 120 which are spread outward. The first cut-away portions 125 are formed by cutting away both edges of each spread portion by a predetermined width. Preferably, the first cut-away portions 125 are formed by cutting away the spread portions including the ends, in which the hooking portions 122 are formed, except upper sides of the spread portions. Since a width of each retaining arm 120, i.e., a length of each hooking portion 122 may be formed to have a predetermined dimension, an elastically hooking degree of the hooking portions 122 may be controlled by the first cut-away portions 125. Further, a distance between the retaining arms 120 and the guides 130 to be described may be increased, and thus even when the fixture F of the present invention is twisted and thus the guides 130 are severely deformed, the hooking portions 122 are prevented from being separated from or escaping from the installation hole 11 because of a sufficient gap between the guides 130 and the retaining arms 120.

As illustrated in FIG. 6, the retaining arms 120 are formed to be spared more widely than a width of the installation hole 11, and when the retaining arms 120 are inserted into the installation hole 11, the retaining arms 120 are interfered with the installation hole 11, forcibly deformed in a direction facing each other, and then returned to their original positions, and thus the hooking portions 122 are caught and fixed into the installation hole 11.

As illustrated in FIGS. 4 to 6, four guides 130 are formed to be located at both sides of each retaining arm 120, respectively. At this time, as illustrated in FIG. 6, the guides 130 are formed to be located between the retaining arms 120 and the installation hole 11, when the retaining arms 120 are inserted into the installation hole 11. Due to this configuration, when the indoor handle is pulled and thus fixture F of the present invention is pulled down, the retaining arms 120 and the guides 130 are moved together, and also gaps therebetween are minimized. Therefore, even when the twisting force or the external vibration is applied to the retaining arms 120, the retaining arms 120 are prevented from being separated or escaping from the installation hole 11.

Further, the guides 130 are formed to have a predetermined length so that ends thereof protrude to an outer side of the installation hole 11, when the fixture F of the present invention is inserted into the installation hole 11. Therefore, when the retaining arms 120 are inserted into the installation hole 11, the guides 130 serve to guide the retaining arms 120, such that the retaining arms 120 are located at predetermined positions.

In the preferred embodiment of the present invention, it is preferable that the guides 130 be bent as least twice, and bent portions thereof be directed to an outer side of the base 100, and adjacent surfaces thereof be in contact with each other. Due to this configuration, the bent portions are formed to be smooth and thus to ensure its own stiffness while being easily inserted into the installation hole 11.

As illustrated in FIG. 6, when the fixture F of the present invention is installed into the installation hole 11, the guides 130 are located between the retaining arms 120 and an inner surface of the installation hole 11, and the retaining arms 120 are prevented from being directly in contact with the installation hole 11, even when the twisting force is applied to the fixture F. Therefore, even though the twisting force or the vibration is applied to the retaining arms 120, and the retaining arms 120 themselves are twisted, the retaining arms 120 are not in contact with the inner surface of the installation hole 11, and friction is not generated therebetween, and the retaining arms 120 are prevented from being easily separated from the installation hole 11.

As described above, the fixture of the present invention can be easily manufactured and also massively produced by press processing of a steel material or injection molding of a synthetic resin. In particular, the partial separation or the complete separation of the retaining arms is prevented, and thus it is possible to reduce the noise and also to prevent the safety accident.

The fixture for the vehicle according to the present invention has the following effects.

(1) In the case of the indoor handle to which the external force is applied by a passenger, as well as the headliner, the room lamp, and the head lamp to which the external force is hardly applied, once they are fixed, the external force can be effectively dispersed.

(2) That is, since a point-contact is achieved between the retaining arms, the contact area can be minimized, even when a force is applied to the fixture of the present invention. Therefore, the noise generated when the retaining arms collide with each other can be minimized.

(3) The cut-away portions are formed at both sides of each retaining arm, and thus a length of the hooking portions can be reduced. Therefore, the elasticity of the hooking portions actually serving as the hooks can be controlled, and the distance between the retaining arms and the guides can be increased, and thus even when the guides are deformed by the force applied to the fixture of the present invention, the retaining arms are not affected by the deformation of the guides, and thus are prevented from escaping from or being separated from the installation hole.

(4) The retaining arms caught and hooked into the installation hole can be manufactured to have a wide width. Therefore, the fixing force generated when the retaining arms are caught into the installation hole can be increased, and thus the fixture of the present invention can be fixed not to be separated from or escape from the installation hole.

(5) The guides are provided between the retaining arms and the installation hole, and thus the retaining arms are prevented from being directly in contact with the installation hole, even when the retaining arms are twisted or deformed due to the vibration so that the retaining arms are prevented from easily escaping from or being separated from the installation hole.

(6) Therefore, the fixture of the present invention can be firmly fixed to the indoor handle, and also the noise generated when the retaining arms separated from the installation hole collide with the body panel or other construction elements therearound can be prevented, and thus the riding comfort can be improved.

(7) Further, the retaining arms can be prevented from completely escaping from the installation hole, and thus the fixture can be prevented from being separated from the body panel together with the indoor handle. Therefore, the safety accident which may occur while the indoor handle falls into an interior of the vehicle due to complete separation thereof can be prevented in advance.

(8) The guides are configured to guide the fixture, when the fixture of the present invention is inserted into the installation hole, and thus the fixture can be guided and easily inserted into the installation hole. Therefore, in addition to the reduction of the nose and the prevention of the safety accident, the fixture of the present invention can be easily and rapidly assembled, and the productivity can be improved.

(9) In particular, the guides are formed so that the both surfaces thereof protruding upward from the base are in contact with each other, and thus the guides can be easily coupled through a self-deformation, when the fixture is coupled. Further, the guides can be integrally formed with the base by the press processing or the injection molding, and assembling efficiency can be improved.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A fixture for a vehicle, which is inserted into an installation hole formed in a body panel to install a head lamp, a room lamp, a headliner, or an indoor handle, comprising:
a base having a fastening hole formed in a center thereof;
one pair of retaining arms configured to extend at both sides of the base based on the fastening hole to face each other, and to be in contact with each other above the fastening hole, and then to be spread outward toward a lower side thereof, and having hooking portions formed at ends thereof to be elastically deformed and thus to be caught and fixed into the installation hole, and first cut-away portions formed at both sides thereof by partly cutting away edges of portions thereof which are spread outward by a predetermined width; and
four guides configured to protrude from the base and to be located between both sides of each retaining arm and an inner surface of the installation hole, and formed to protrude upward when the fixture is inserted into the installation hole.

2. The fixture of claim 1, wherein the retaining arms have second cut-away portions formed by partly cutting away portions bent above the fastening hole to easily achieve an elastic deformation.

3. The fixture of claim 1, wherein each retaining arm has at least one reinforcing bead formed to reinforce a structural strength thereof in a lengthwise direction.

4. The fixture of claim 1, wherein the retaining arms have at least one contacting protrusion formed at each of both surfaces thereof which are in contact with each other above the fastening hole, such that one contacting protrusion formed at one retaining arm is not in contact with the other contacting protrusion formed at the other retaining arm.

5. The fixture of claim 1, wherein the guides are formed to be bent at least twice, such that adjacent surfaces thereof are in contact with each other.

6. The fixture of claim 1, wherein the fixture is formed by press processing of a steel material or injection molding of a synthetic resin.

7. The fixture of claim 2, wherein the fixture is formed by press processing of a steel material or injection molding of a synthetic resin.

8. The fixture of claim 3, wherein the fixture is formed by press processing of a steel material or injection molding of a synthetic resin.

9. The fixture of claim 4, wherein the fixture is formed by press processing of a steel material or injection molding of a synthetic resin.

10. The fixture of claim 5, wherein the fixture is formed by press processing of a steel material or injection molding of a synthetic resin.
